(19) United States
(12) Patent Application Publication
(10) Pub. No.: US 2017/0130485 A1
(43) Pub. Date: May 11, 2017

(54) Insulating Guide for Walk-in Commercial Refrigerator and Freezer Plunger-type Internal Door Latch Release

(71) Applicants: Timothy David DODGE, Whitehall, PA (US); Matthew JAmes Vasallo, Allentown, PA (US)

(72) Inventors: Timothy David DODGE, Whitehall, PA (US); Matthew JAmes Vasallo, Allentown, PA (US)

(21) Appl. No.: 14/934,676

(22) Filed: Nov. 6, 2015

(51) Int. Cl. E05B 65/00

(52) U.S. Cl. CPC E05B 65/0053; E05B 65/001

(57) ABSTRACT

A safety latch release apparatus for an institutional walk-in refrigerator or freezer cabinet doors provided with a bushing inserted into the mounting plate and surrounding the plunger rod for substantially blocking the internal cabinet air from flowing into the latch release pathway through the door to the external latch release assembly. The bushing also provides enhanced support and positional guidance to maintain the plunger rod centered along the annular opening of the mounting plate and bushing so that the rod is properly operationally aligned with the rear side of the handle latch assembly.

### BACKGROUND OF THE INVENTION

The present invention provides for the release of the door latch of a walk-in refrigerator or freezer from the inside regardless of whether the latch has been disabled by a locking mechanism positioned on the door exterior. For more than fifty years door latches for walk-in refrigerators and freezers have been provided with safety latch release mechanisms operable from inside the cabinet. Some of these release mechanisms involved the rotating of a shaft to disengage the latch mechanism. However, the vast majority of the safety release latch mechanisms involved a plunger-type release that is operated through the door by pushing against a complex mechanical safety latch release mechanism that retracted the latch tongue or disengaged the force against the tongue to release the door.

Earlier versions of the plunger-type safety release mechanisms operated directly on the latch handle and included a sleeve extending through the door to accurately position the plunger against the inside surface of the latch handle so as to operate the latch handle from within the cabinet. An example of this type of safety release mechanism is shown and described in U.S. Pat. No. 2,617,287 [Tobias]. Another release mechanism is shown and described in U.S. Pat. No. 2,747,906 [Emmert] where the plunger rod operates directly on the latch keeper roller, moving it out of its normal position to allow the door to open. Still another mechanism is described and shown in U.S. Pat. No. 2,680,638 [Groeger] that operates on a latch extension rod by displacing that extension rod on the operation of the plunger to counteract the spring force and retract the latch from its normal extended position. All of these versions of the safety internal door latch release mechanisms required mountings on the inside of the door in combination with sleeves extending through the door or couplings to the latch body on the exterior of the door. In each case, the channel extending through the door was capable of transferring the colder air within the refrigerator or freezer outward and against or into the latch mechanism with the result being an inherent buildup of frost and ice that could foul or interrupt the safe operation of the safety release latch mechanism. These were the safety latch releases utilized in the industry beginning in the 1950's and continuing until the mid-1970's.

In the mid-1970's exterior walk-in refrigerator and freezer door latches were adapted to incorporate a portion extending through to the interior of the door and be directly connected to the plunger-type door latch. One example of this extended internal structure is described and shown in U.S. Pat. No. 3,936,086 [Berkowitz] that shows the plunger directly operating on the latch keeper to push the keeper out of the latch and release the door from the inside of the cabinet. In approximately 1980 this direct operation was modified such that the depression of the plunger release operated against a series of interconnected arms that draw the latch keeper away from the roller in the same fashion as if the handle on the exterior were pulled. Examples of these mechanisms are described and shown in U.S. Pat. No. 4,202,573 [Berkowitz, et al.] and in U.S. Pat. No. 4,203,622 [Cook]. Slightly different versions of these mechanisms are also shown and described in U.S. Pat. No. 4,372,591 [Cook] and in U.S. Pat. No. 4,280,725 [Berkowitz, et al.]. One can readily view a receiver/guide incorporated into the back plate of the exterior patch mechanism to properly position and guide the plunger safety release into and against the appropriate latch release mechanisms within the latch bodies of the respective devices.

It is also important to note that the earlier sleeves extending through the door have now been discarded with only a centering annular opening in the back plate on the interior of the door and the receiver guide on the back plate of the latch mechanism. These mechanisms lack any protection afforded against the transmission of lower temperature air entering the safety latch communication pathway in the door, which is no longer solid and contains only insulation between the interior and exterior metal sheaths. There is also lacking any protection against the accumulation of moisture within the door due to condensation when colder air comes into contact with warmer materials on the exterior door surface. Further, there is no protection against moisture accumulating at or inside the latch with its back plate exposed to the interior of the door to accommodate the safety latch release rod, or against that moisture forming frost and/or ice and preventing the latch mechanism from properly operating when using the safety latch release. In addition, the plunger rod is normally a metal, e.g., brass or stainless steel, that transmits the temperature from within the cabinet to its distal tip located immediately proximate to the back plate of the external latch mechanism extending to the interior of the door creating a temperature at that location at approximately the temperature maintained inside the cabinet. Current models being used on today's walk-in refrigerator and freezer doors remain unchanged from the mechanisms described above.

It is an object of the present invention to significantly reduce any air transmission from the interior of the cabinet, through the safety latch communication pathway within the door, to the door latch mechanism on the exterior of the door eliminating the potential for failure of the safety latch to properly operate by the formation of frost and/or ice along the back or the interior of the latch mechanism. It is another object of the present invention to significantly restrict air flow into and through the communicating channel in the door so that the metal plunger rod, even at cabinet temperature, has little or no moisture to create frost that may freeze and disrupt the operation of the release mechanism. It is a further object of the present invention to provide a guide to retain the safety release rod centered along the communication pathway so that false strikes against the latch release mechanism do not occur due to a potential misalignment of the safety release rod against or into the door latch mechanism. It is also an object of the present invention to prevent the misalignment of the safety release rod by preventing it from being withdrawn from the guide by restricting its outward travel.

Other objects will appear hereinafter.

### SUMMARY OF THE INVENTION

A safety latch release apparatus for an institutional walk-in refrigerator or freezer cabinet door is described as having an elongated rod mounted to the inside of the cabinet door by a mounting plate with the rod extending through an open channel within the cabinet door to the rear side of a handle latch release assembly mounted to the exterior of the cabinet door. The handle latch release assembly has an aperture on the rear side of the release assembly exposed to the open channel and is capable of cooperatively accepting the distal end of the elongated rod such that the inward pushing of the elongated rod against the door will operate a safety latch release mechanism within the handle latch release assembly opening the cabinet door from inside the cabinet. The improvement in the safety latch release apparatus includes a T-bushing mounted by press fitting the bushing within an annular opening in the mounting plate and extending through the mounting plate a predetermined distance along the elongated rod retained in position along the rod by an internal toothed washer impressed onto the extended collar of the T-bushing and against the inward facing surface of the mounting plate. The T-bushing shoulder portion that covers the annular junction between the mounting plate and the T-bushing blocks the inflow of air from inside the cabinet into the channel through the annular junction. The T-bushing has an internal diameter substantially the same as the external diameter of the elongated rod so as to significantly reduce any air inflow into the open channel around the elongated rod within the door. The safety latch release assembly includes a compressible collar overlying and surrounding the extended collar of the T-bushing along the rod providing additional insulation against air flow through the annular opening of the mounting plate. The T-bushing further provides support and positional guidance to maintain the elongated rod centered along the annular opening of the mounting plate and T-bushing so that the rod is properly operationally aligned with the aperture on the rear side of the handle latch assembly. In this way the air inflow from the interior of the cabinet is prevented from entering into the open channel through the cabinet door by the T-bushing and the operation of the elongated rod is enhanced by the positional guidance provided through reduction of the annular opening in the mounting bracket by the T-bushing.

The safety latch release assembly may also include a second T-bushing that is mounted through the aperture in the rear plate of the handle latch assembly. The T-bushing shoulder portion covers the opening in the rear plate such that the T-bushing blocks the inflow of air from outside the cabinet into the channel through the opening in the rear plate of the handle latch assembly. The second T-bushing also has an internal diameter substantially the same as the external diameter of the elongated rod so as to significantly reduce any air inflow into the open channel around the elongated rod within the door. The second T-bushing also provides support and positional guidance to maintain the elongated rod centered along the annular opening of the mounting plate and T-bushing so that the rod is properly operationally aligned with the aperture in the rear plate of the handle latch assembly.

The safety latch release assembly also includes a retaining ring held against the mounting plate and T-bushing by a pin extending diametrically through the elongated rod and resting against the retaining ring to prevent the rod from being withdrawn from the safety latch release assembly beyond the contact point with the mounting plate so that the elongated rod remains properly aligned within the T-bushing and mounting plate at all times. The safety latch release assembly further includes a push handle or knob located at the proximal end of the elongated rod extending into the cabinet having a centered annular collar for cooperatively accepting the proximal end of the elongated rod with said push handle held in position on the elongated rod by a pin extending diametrically through the elongated rod and the push handle collar.

The safety latch release assembly may also include a recessed push handle or knob used with a recessed mounting plate extending inward into the cabinet door such that the push handle does not extend beyond the inward facing surface of the cabinet door.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a perspective view of an exterior door latch mounted to the door and frame of a walk-in refrigerator or freezer cabinet with the safety latch release rod exploded away from the latch toward the interior of the of the cabinet.

FIG. 2 is a side view of the assembled safety latch release of the present invention.

FIG. 3 is an exploded view of the safety latch release of the present invention showing individual elements and their respective placement along the safety latch release rod.

### DETAILED DESCRIPTION OF THE PREFERRED EMBODIMENTS

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

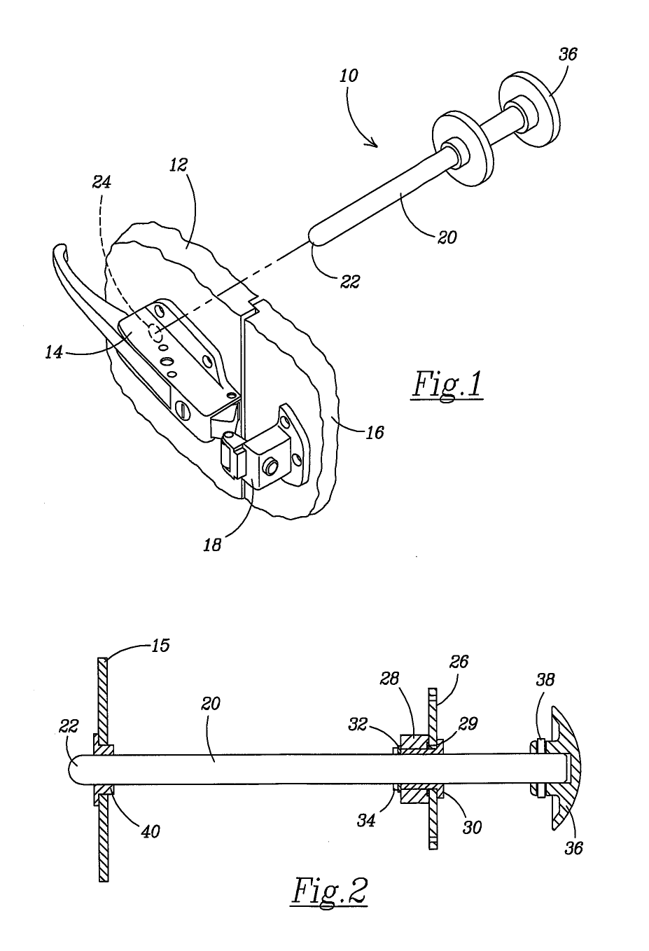

Referring now to the drawings in detail, where like numerals refer to like parts or elements, there is shown in FIG. 1 the safety latch release 10 of the present invention with the dashed line indicating a connection with the exterior latch mechanism mounted to the cabinet door. The safety latch release 10 resides primarily within the door 12 of a walk-in refrigerator or freezer cabinet, extending from the interior surface to the exterior surface of the door 12 and through the back plate of the latch handle assembly 14 to contact the latch release within the assembly 14. Alternatively, the safety latch release 10 can extend through the frame of the cabinet 16 to contact the latch keeper 18 rather than the latch handle assembly 14. Although operation is similar in either instance for the safety latch release 10, as a significant number of safety latch release mechanisms operate directly with the latch handle assembly 14, the following description will focus on that relationship.

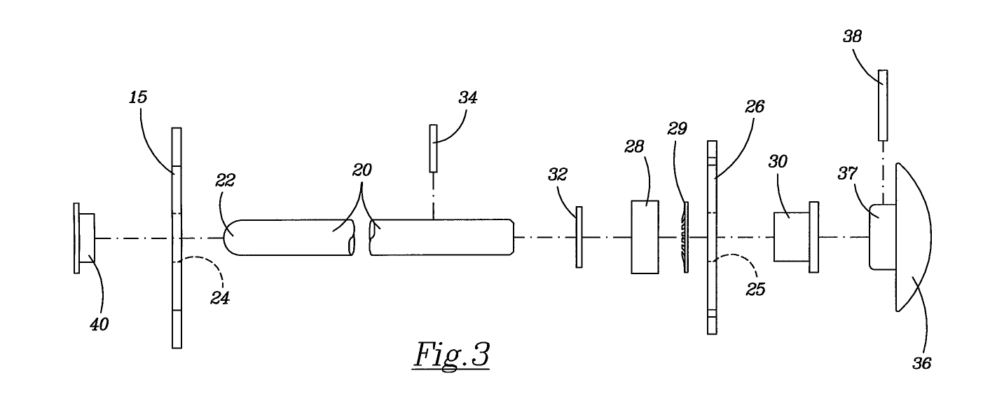

Referring now to FIGS. 2 and 3, the safety latch release 10 includes an elongated plunger rod 20 having its distal end 22 rounded to more easily fit into and through an aperture 24 in the back plate 15 of the latch handle assembly 14 and contact the latch release mechanism (not shown) housed within the assembly 14. Maintaining the plunger rod 20 in alignment with the aperture 24 of the handle latch assembly 14 is the mounting plate 26 extending inward into and through the inner sheath of the door 12. The mounting plate 26 has an axially aligned central aperture 25 therethrough of a diameter sufficient to accommodate the approximate exterior diameter of the plunger rod 20. However, in the case of the present invention, that internal diameter is reduced by the introduction into that axially aligned aperture 25 a T-bushing 30 having an external diameter that more closely approximates the interior diameter of the mounting plate 26. The T-bushing 30 is press fit into position within the central aperture 25 of mounting plate 26 extending from the outer surface of the mounting plate 26 a predetermined distance to the rear or inward facing side of the mounting plate 26 and is retained in that position through the use of an undersized internal toothed washer 29 that is press fit over the exterior collar portion of the T-bushing 30 extending along the rod 20 bending the teeth away from the shoulder portion of the T-bushing 30 such that the T-bushing can no longer be removed from the mounting plate 26. Although this is the preferred manner of securing the T-bushing 30 in position along the rod, any other suitable attachment mechanism could be utilized to retain the T-bushing 30 in place within the annular opening 25 in the mounting plate 26.

The shoulder portion of the T-bushing 30 will lie directly against the outer surface of the mounting plate 26 overlying the central aperture 25 of the mounting plate 26 blocking air transmission therethrough when positioned properly. The internal diameter of the T-bushing 30 and the external diameter of the plunger rod 20 are substantially the same so that there is guiding support for the rod 20 by the T-bushing 30 along the centerline of the annular opening of the combination of the mounting plate 26 and the T-bushing 30 mounted therein without limiting the freedom of longitudinal motion of the plunger rod 20 through the T-bushing 30.

The introduction of the T-bushing 30 provides additional support and guidance for the plunger rod 20, and also closes off an air flow pathway that existed in the annular space between the exterior of the plunger rod 20 and the interior wall of mounting plate 26. An additional compressible material, e.g., a cylindrical felt bumper, in the form of a collar 28 is placed over the extended portion of the T-bushing 30 along the rod 20 to provide an additional insulating member for closing off air flow through the door 12 by passage of the chilled air through the emergency latch release communication channel. By closing off the air flow pathway, the T-bushing 30 and collar 28 substantially prevent chilled air within the refrigerator or freezer cabinet from entering the insulated door and continuing through the safety latch release channel to the exterior of the door 12 and the latch handle assembly 14. The addition of the T-bushing 30 with its reduction in the diameter of the annular opening 25 of the mounting plate 26 and with the addition of the compressible collar 28 significantly, if not entirely, eliminates the potential for chilled air to escape the cabinet and flow into the interior of the door 12 and outward into the latch handle assembly 14 to contact warmer moister air causing condensation in the chilled air environment resulting in frost and ice buildup on the internal operating parts of the latch handle assembly 14. The prevention of the chilled air flow will also prevent the material of the plunger rod 20, i.e., the brass or stainless steel metal or plastic material, from causing condensation of any air within the safety latch release channel when exposed to potentially warmer surfaces at the exterior door sheath or exterior latch assembly 14.

The plunger rod 20 of the safety latch release 10 is held in position so that it cannot be withdrawn from the inside of the door 12 by a retaining ring or washer 32 positioned around the rod 20 and against the extension of the T-bushing 30 extending inward into the door 12. The retaining ring 32 is held against the T-bushing 30 by pin 34 that extends diametrically through plunger rod 20. The pin 34 extending through the plunger rod 20 does not allow the rod to be withdrawn from the remainder of the safety latch release assembly 10 beyond the contact point with the inward extension of the T-bushing 30 so the plunger rod 20 remains properly aligned within the T-bushing 30 and mounting plate 26 at all times.

At the proximal end of the safety latch release 10 the plunger rod 20 is connected to the push handle or knob 36 by inserting the rod 20 into a cooperating central annular collar 37 within the handle 36. The plunger rod 20 is held in position within the annular collar 37 by a pin 38 that extends diametrically through the plunger rod 20 so that the rod remains fixed within the annular collar 37 of handle 36. In this manner the movement of the handle 36 inward toward the door 12 causes the plunger rod 20 to likewise move inward and contact the latch release mechanism within the latch handle assembly 14 on the exterior of the door 12 releasing the latch and allowing the door 12 to open as if the external handle were used.

The safety latch release 10 described above has a handle 36 that protrudes inwardly from the door 12. There also exist recessed safety release handles that extend only to the surface of the door 12 with the mounting plate 26 and collar 28 recessed inward into the door 12 a like distance to the inward dimension of the recessed mounting plate. The present invention will operate in the same manner if a recessed mounting plate is used, only with a shorter plunger rod 20 so that the safety release handle 36 remains recessed within the door.

In operation the safety release latch mechanism 10 of the present invention provides a shield against the influx of colder air from within the cabinet into the safety release latch channel through the door by the introduction of the T-bushing 30 into the annular opening in the mounting plate 26, reducing the annular opening therethrough to substantially the diameter of the plunger rod 20. The T-portion of the T-bushing 30 overlies the annular opening in the mounting plate 26 also preventing air inflow into the safety release channel through the door 12. With the decrease in the diameter of the annular opening in the mounting plate 26 by the T-bushing 30 to a diameter substantially the same as the external diameter of the plunger rod 20, coupled with the T-bushing extending through the mounting plate 26 a predetermined distance along and to the rear or distal end of the plunger rod 20, there is provided an additional positional guidance to maintain the plunger rod 20 centered along the annular opening of the mounting plate 26 and T-bushing 30 so that the rod is properly aligned with the aperture 24 of the handle latch assembly 14. In addition, the compressible collar 28 surrounding the extension portion of the T-bushing 30 and lies directly against the inward facing side of the mounting plate 26 provides additional thermal insulation to the combination. In this way the addition of the T-bushing 30 and collar 28 significantly increases the insulation factor between the interior of the cabinet and the interior of the door by reducing air inflow to a minimum thereby decreasing the chance that the safety latch release mechanism will fail due to frost and/or ice buildup at the entry to the handle latch assembly 14 or in the safety latch release mechanism therein.

A further enhancement of the guidance and insulative function of the safety latch release mechanism is to add a second T-bushing 40 that is press fit into and through the aperture 24 in the back plate 15 of the latch handle assembly 14. The second T-bushing 40 has an external diameter that closely approximates the aperture 24 in the back plate 15 with the internal diameter of the T-bushing 40 and the external diameter of the plunger rod 20 being substantially the same. The shoulder portion of the T-bushing 40 will lie directly against the inner surface of the back plate 15 overlying the aperture 24 of the back plate 15 blocking air transmission therethrough when positioned properly and providing a guiding support for the proper operation of the plunger rod 20 along the centerline of the annular openings of the combination of the mounting plate 26 and the T-bushing 30 and the back plate 15 and second T-bushing 40 without limiting the freedom of longitudinal motion of the plunger rod 20 through the T-bushing 30 or the second T-bushing 40. With the addition of the second T-bushing 40, any warmed air from outside of the door 12 remains outside, prevented from penetrating into the emergency latch release communication channel by the second T-bushing 40. Further, the second T-bushing 40 acts as an insulative member in providing a buffer between any warmed air within the latch handle assembly 14 and any chilled air within the emergency latch release communication channel. The second T-bushing 40 also is capable of receiving the distal end 22 of the plunger rod 20 and retaining the rod 20 aligned along the centerline of the emergency latch release communication channel existing within the door 12 between opening 24 in the rear plate 15 of the latch handle assembly 14 and the central annular opening 25 of the mounting plate 26. In this way the chilled air remains away from the exterior latch handle assembly 14 and its operable parts and the safety release latch mechanism 10 is always properly aligned for its safe and efficient operation.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A safety latch release apparatus for an institutional walk-in refrigerator or freezer cabinet door having an elongated rod having proximal and distal ends mounted to the inside of the cabinet door by a mounting plate and extending through an open channel within the cabinet door to the rear side of a handle latch release assembly mounted to the exterior of the cabinet door having an aperture on the rear side of said handle latch release assembly exposed to said open channel and capable of cooperatively accepting the distal end of the elongated rod such that the inward pushing of the elongated rod against the door will operate a safety latch release mechanism within the handle latch release assembly opening the cabinet door from inside the cabinet, the improvement comprising:
a T-bushing mounted by press fitting within an annular opening in the mounting plate and extending through the mounting plate a predetermined distance along the elongated rod retained in position along the rod by an internal toothed washer impressed onto the extended collar of the T-bushing and against the inward facing surface of the mounting plate, said T-bushing shoulder portion covering the annular junction between the mounting plate and the T-bushing collar blocking any inflow of air from inside the cabinet into the channel through said annular junction;
said T-bushing having an internal diameter substantially the same as the external diameter of the elongated rod so as to significantly reduce any air inflow into the open channel around the elongated rod within the door and to provide support and positional guidance to maintain the elongated rod centered along the annular opening of the mounting plate and T-bushing so that the rod is properly operationally aligned with the aperture on the rear side of the handle latch assembly,
whereby air inflow from the interior of the cabinet is prevented from entering into the open channel through the cabinet door by the T-bushing and the operation of the elongated rod is enhanced by the positional guidance provided through reduction of the annular opening in the mounting bracket by the T-bushing.

2. The safety latch release apparatus of claim 1, further comprising a compressible collar overlying and surrounding the extended collar of the T-bushing along the rod providing additional insulation against air flow through the annular opening of the mounting plate.

3. The safety latch release assembly of claim 1, further comprising a retaining ring held against the mounting plate and T-bushing and a pin extending diametrically through the elongated rod and resting against the retaining ring to prevent the rod from being withdrawn from the safety latch release assembly beyond the contact point with the mounting plate so that the elongated rod remains properly aligned within the T-bushing and mounting plate at all times.

4. The safety latch release assembly of claim 1, further comprising a push handle located at the proximal end of the elongated rod extending into the cabinet having a centered annular collar for cooperatively accepting the proximal end of the elongated rod with said push handle held in position on the elongated rod by a pin extending diametrically through the elongated rod and the push handle collar.

5. The safety latch release assembly of claim 1, further comprising a second T-bushing mounted by press fitting within a circular opening in the back plate of the handle latch release assembly and extending through the back plate a predetermined distance, said T-bushing shoulder portion covering the annular junction between the opening in the back plate and the T-bushing collar blocking any inflow of air from outside the cabinet into the channel through said annular junction, said second T-bushing having an internal diameter substantially the same as the external diameter of the elongated rod so as to significantly reduce any air inflow into the open channel around the elongated rod within the door and to provide support and positional guidance to maintain the elongated rod centered along the circular opening of the back plate so that the rod is properly operationally aligned with the aperture on the rear side of the handle latch assembly.

6. A safety latch release apparatus for an institutional walk-in refrigerator or freezer cabinet door comprising:
an elongated rod having proximal and distal ends mounted to the inside of the cabinet door by a mounting plate and extending through an open channel within the cabinet door to the rear side of a handle latch release assembly mounted to the exterior of the cabinet door, said handle latch release assembly having an aperture on the rear side exposed to said open channel;
a T-bushing mounted by press fitting within an annular opening in the mounting plate and extending through the mounting plate a predetermined distance along the elongated rod retained in position along the rod by an internal toothed washer impressed onto the extended collar of the T-bushing and against the inward facing surface of the mounting plate, said T-bushing shoulder portion covering the annular junction between the mounting plate and the T-bushing blocking any inflow of air from inside the cabinet into the channel through said annular junction;
said T-bushing having an internal diameter substantially the same as the external diameter of the elongated rod so as to significantly reduce any air inflow into the open channel around the elongated rod within the door and to provide support and positional guidance to maintain the elongated rod centered along the annular opening of the mounting plate and T-bushing so that the rod is properly operationally aligned with the aperture on the rear side of the handle latch assembly,
said aperture on the rear side of said handle latch release assembly being capable of cooperatively accepting the distal end of the elongated rod such that the inward pushing of the elongated rod against the door will operate a safety latch release mechanism within the handle latch release assembly opening the cabinet door from inside the cabinet,
whereby air inflow from the interior of the cabinet is prevented from entering into the open channel through the cabinet door by the T-bushing and the operation of the elongated rod is enhanced by the positional guidance provided through reduction of the annular opening in the mounting bracket by the T-bushing.

7. The safety latch release apparatus of claim 6, further comprising a compressible collar overlying and surrounding the extended collar of the T-bushing along the rod providing additional insulation against air flow through the annular opening of the mounting plate.

8. The safety latch release assembly of claim 6, further comprising a retaining ring held against the combination of the mounting plate and T-bushing and a pin extending diametrically through the elongated rod and resting against the retaining ring to prevent the rod from being withdrawn from the safety latch release assembly beyond the contact point with the combination of the mounting plate and T-bushing so that the elongated rod remains properly aligned within the T-bushing and mounting plate at all times.

9. The safety latch release assembly of claim 6, further comprising a push handle located at the proximal end of the elongated rod extending into the cabinet having a centered annular collar for cooperatively accepting the proximal end of the elongated rod with said push handle held in position on the elongated rod by a pin extending diametrically through the elongated rod and the push handle collar.

10. The safety latch release assembly of claim 6, further comprising a second T-bushing mounted by press fitting within a circular opening in the back plate of the handle latch release assembly and extending through the back plate a predetermined distance, said T-bushing shoulder portion covering the annular junction between the opening in the back plate and the T-bushing collar blocking any inflow of air from outside the cabinet into the channel through said annular junction, said second T-bushing having an internal diameter substantially the same as the external diameter of the elongated rod so as to significantly reduce any air inflow into the open channel around the elongated rod within the door and to provide support and positional guidance to maintain the elongated rod centered along the circular opening of the back plate so that the rod is properly operationally aligned with the aperture on the rear side of the handle latch assembly.

11. A safety latch release apparatus for an institutional walk-in refrigerator or freezer cabinet door comprising:
an elongated rod having proximal and distal ends mounted to the inside of the cabinet door by a mounting plate having an annular opening therethrough and extending through an open channel within the cabinet door to the rear side of a handle latch release assembly mounted to the exterior of the cabinet door, said handle latch release assembly having an aperture on the rear side exposed to said open channel for receiving said elongated rod, said aperture being capable of cooperatively accepting the distal end of the elongated rod such that the inward pushing of the elongated rod against the door will operate a safety latch release mechanism within the handle latch release assembly opening the cabinet door from inside the cabinet; and,
at least one T-bushing extending completely around the elongated rod at one of the proximal and distal ends of the elongated rod, said T-bushing shoulder portion covering the annular junction between the elongated rod and said mounting plate at the proximal end of the rod or the annular junction between the elongated rod and said aperture on the rear of the handle latch release assembly, said at least one T-bushing blocking any inflow of air into the channel through said proximal or distal annular junctions,
whereby air inflow is prevented from entering into the open channel through the cabinet door by the at least one T-bushing and the operation of the elongated rod is enhanced by the annular positional guidance of the elongated rod provided by the at least one T-bushing.

12. The safety latch release apparatus of claim 11, wherein the at least one T-bushing being positioned at the proximal end of the elongated rod and retained in position along said rod by an internal toothed washer impressed onto the extended collar of the T-bushing and against the inward facing surface of said mounting plate.

13. The safety latch release apparatus of claim 11, wherein the at least one T-bushing being positioned at the proximal end of the elongated rod having an internal diameter substantially the same as the external diameter of the elongated rod so as to significantly reduce any air inflow into the open channel around the elongated rod within the door and to provide support and positional guidance to maintain the elongated rod centered along the annular opening of the mounting plate and T-bushing so that the rod is properly operationally aligned with the aperture on the rear side of the handle latch assembly.

14. The safety latch release apparatus of claim 11, further comprising a compressible collar overlying and surrounding the extended collar of the at least one T-bushing positioned at the proximal end of the elongated rod inward along the rod providing additional insulation against air flow through the annular opening of the mounting plate.

15. The safety latch release assembly of claim 11, further comprising a retaining ring held against the combination of the mounting plate and the at least one T-bushing positioned at the proximal end of the elongated rod and a pin extending diametrically through the elongated rod and resting against the retaining ring to prevent the rod from being withdrawn from the safety latch release assembly beyond the contact point with the combination of the mounting plate and T-bushing so that the elongated rod remains properly aligned within the T-bushing and mounting plate at all times.

16. The safety latch release assembly of claim 11, further comprising a push handle located at the proximal end of the elongated rod extending into the cabinet having a centered annular collar for cooperatively accepting the proximal end of the elongated rod with said push handle held in position on the elongated rod by a pin extending diametrically through the elongated rod and the push handle collar.

17. The safety latch release apparatus of claim 11, wherein the at least one T-bushing being positioned at the distal end of the elongated rod and mounted by press fitting within said aperture in the back plate of the handle latch release assembly and extending through the back plate a predetermined distance, said T-bushing shoulder portion covering the annular junction between the aperture in the back plate and the T-bushing collar blocking any inflow of air from outside the cabinet into the channel through said annular junction, said at least one T-bushing having an internal diameter substantially the same as the external diameter of the elongated rod so as to significantly reduce any air inflow into the open channel around the elongated rod within the door and to provide support and positional guidance to maintain the elongated rod centered within the aperture of the back plate so that the rod is properly operationally aligned with the aperture on the rear side of the handle latch assembly.

18. The safety latch release apparatus of claim 11, wherein a set of T-bushings extending completely around the elongated rod at both the proximal and distal ends of the elongated rod, said set of T-bushings shoulder portions covering the annular junction between the elongated rod and said mounting plate at the proximal end of the rod and the annular junction between the elongated rod and said aperture on the rear of the handle latch release assembly, said set of T-bushings blocking any inflow of air into the channel through said proximal or distal annular junctions with the elongated rod.
